(19) United States
(12) Patent Application Publication
(10) Pub. No.: US 2020/0125245 A1
(43) Pub. Date: Apr. 23, 2020

(54) CONTROL DEVICE, COMMUNICATION TERMINAL, AND CONTROL SYSTEM

(71) Applicant: FANUC CORPORATION, Yamanashi (JP)

(72) Inventors: Kouji OSADA, Yamanashi (JP); Toshinori MATSUKAWA, Yamanashi (JP)

(21) Appl. No.: 16/556,812

(22) Filed: Aug. 30, 2019

(30) Foreign Application Priority Data
Oct. 19, 2018 (JP) 2018-197724

(51) Int. Cl. G06F 3/0484; G06F 3/0482; G06F 3/14; G05B 19/416

(52) U.S. Cl. CPC G06F 3/04847; G06F 3/0482; G05B 2219/36343; G05B 19/416; G05B 2219/50391; G06F 3/14

(57) ABSTRACT

Screen information including a contents image required by an operator of a terminal is received from a control device and is displayed on a display unit. A control device includes: a first screen information creation unit that creates at least one piece of first screen information; a second screen information creation unit that creates second screen information including a contents image on the basis of at least one contents image selected from the first screen information by a communication terminal and layout information of a screen selected by the communication terminal; and a communication unit that transmits the first screen information and the second screen information to the communication terminal and receives the layout information of the screen and the contents image or the selection information of the contents image from the communication terminal.

This application is based on and claims the benefit of priority from Japanese Patent Application No. 2018-197724, filed on 19 Oct. 2018, the content of which is incorporated herein by reference.

### BACKGROUND OF THE INVENTION

### Field of the Invention

The present invention relates to a control device that provides screen information including contents images required by an operator of a terminal, a communication terminal that displays screen information transmitted from the control device, and a control system including the control device and the communication terminal.

### Related Art

A control system in which a communication terminal receives screen information transmitted from a control device such as a numerical control device (an NC device) and displays the screen information on a display unit is disclosed in Patent Documents 1 and 2, for example.

Patent Document 1 discloses a remote monitoring device and a monitoring method in an electric discharge machine, enabling an NC screen to be obtained via the Internet from a remote site using a general browser. Specifically, the remote monitoring device of the electric discharge machine includes an electric discharge machine having an NC device and a web server mounted thereon, a browser connected to the electric discharge machine via a network, a unit that transmits a NC screen from the electric discharge machine to the browser according to a NC screen request, and a unit that displays the transmitted NC screen on a screen of the browser. Patent Document 2 discloses a recording system which facilitates understanding of production information generated in the past. Specifically, the recording system includes a control computer, a terminal, and a server device, and the control computer acquires measurement result data generated by a measurement device (a sensor) that measures a physical amount related to production of products and displays measurement results represented by the acquired measurement result data on a display device. Moreover, the control computer acquires image data representing a screen displayed on the display device and transmits the image data to the server device. The server device receives the image data and stores she image data in a storage device in correlation with identification information of production management data. The terminal acquires the production management data from the server device and displays an image represented by the image data corresponding to the production management data on the display device when displaying a content represented by the production management data on the display device.

Patent Document 1: Japanese Unexamined Patent Application, Publication No. 2002-166328
Patent Document 2: Japanese Unexamined Patent Application, Publication No. 2018-073185

### SUMMARY OF THE INVENTION

The device and the system disclosed in Patent Documents 1 and 2 display image data corresponding to the NC screen or the production management data on a display unit of a terminal. However, the screen information displayed on the display unit of the terminal may include unnecessary information other than the information required by an operator of the terminal. For example, when the NC device is a NC device that controls a machine tool, information for displaying a NC screen indicating an NC machining operation state is transmitted from the NC device to the terminal. When the operator of the terminal is a production manager, not all pieces of the information displayed on the NC screen is necessary but it is sufficient to obtain information necessary for production management. Moreover, when the terminal is a portable device such as a tablet computer, a display unit mounted thereon has a small sine, and it is desirable that information is selected and displayed according to the purpose of the operator.

An object of the present invention is to provide a control device that provides screen information including contents images required by an operator of a terminal, a communication terminal that displays screen information transmitted from the control device, and a control system including the control device and the communication terminal.

(1) A control device according to the present invention is a control device (for example, a control device 100 to be described later) including: a communication unit (for example, a communication unit 109 to be described later) that communicates with a communication terminal (for example, a communication terminal 200 to be described later); a first screen information creation unit (for example, a screen information creation unit 103 to be described later) that creates at least one piece of first screen information; and a second screen information creation unit (for example, a contents image combining unit 105 to be described later) that creates second screen information including the contents image on the basis of at least one contents image selected from the first screen information by the communication terminal and layout information of a screen selected by the communication terminal, wherein the communication unit transmits the first screen information and the second screen information to the communication terminal and receives the layout information of the screen and the contents image or the selection information of the contents image from the communication terminal.

(2) The control device according to (1) may further include: a first screen information storage unit (for example, a screen information storage unit 104 to be described later) that stores the first screen information, wherein the communication unit may receive selection information of the contents image, and the second screen information creation unit may arrange the contents image selected from the first screen information stored in the screen information storage unit in a layout pattern of the layout information on the basis of the selection information.

(3) The control device according to (2) may further include: a second screen information storage unit (for example, a combined screen information storage unit 106 to be described later) that stores the second screen information; and a control unit (for example, a control unit 107 to be described later) that transmits at least one of the second screen information stored in the second screen information storage unit and the screen information stored in the first screen information storage unit via the communication unit on the basis of a transmission request from the communication terminal.

(4) In the control device according to (1), the communication unit and at least some of the first screen information creation unit, the second screen information creation unit, the first screen information storage unit, and the second screen information storage unit may form a web server.

(5) In the control device according to any one of (1) to (4), the control device may be a numerical control device that creates numerical information for driving a machine tool, a robot, or an industrial machine.

(6) A communication terminal according to the present invention is a communication terminal including: a communication unit (for example, a communication unit 202 to be described later) that communicates with a control device (for example, a control device 100 to be described later); a display unit (for example, a display unit 204 to be described later); and a layout pattern storage unit (for example, a layout pattern storage unit 201 to be described later) that stores at least one layout pattern for arranging at least one contents image on a screen to be displayed on the display unit, wherein the communication unit transmits one layout pattern stored in the layout pattern storage unit to the control device, receives first screen information including at least one contents image from the control device, transmits selection information for selecting a contents image from the first screen information to the control device, and receives second screen information in which the contents image selected on the basis of the selection information is arranged in the one layout pattern from the control device.

(7) In the communication terminal according to (6), the first screen information and the second screen information may be received by a browser.

(8) A control system according to the present invention is a control system including: the control device according to any one of (1) to (5); and the communication terminal according to (6) or (7).

According to the present invention, it is possible to receive screen information including contents images required by an operator of a terminal from a control device and display the screen information on a display unit of a communication terminal.

### BRIEF DESCRIPTION OF THE DRAWINGS

FIG. 1 is a block diagram illustrating a configuration of a numerical control system according to a first embodiment of the present invention.

FIG. 2 is a diagram illustrating a configuration example of a machining display screen displayed on a display unit according to screen information.

FIG. 3 is a diagram illustrating an example of a screen ID, a contents ID, and contents arrangement, information stored in a screen information storage unit.

FIG. 4 is a diagram illustrating how a contents image combining unit arranges three contents images of three pieces of screen information in tiles of a layout pattern to create combined screen information.

FIG. 5A is a diagram illustrating an example of a layout pattern stored in a layout pattern storage unit.

FIG. 5B is a diagram illustrating another example of a layout pattern stored in the layout pattern storage unit.

FIG. 5C is a diagram illustrating another example of a layout pattern stored in the layout pattern storage unit.

FIG. 5D is a diagram illustrating another example of a layout pattern stored in the layout pattern storage unit.

FIG. 6 is a diagram illustrating a case in which contents of a screen is selected by a mouse-drag.

FIG. 7 is a diagram illustrating a case in which contents of a screen is selected by a tap on a touch panel.

FIG. 8 is a flowchart illustrating operations of the numerical control device and the communication terminal that form the numerical control system.

### DETAILED DESCRIPTION OF THE INVENTION

Hereinafter, an embodiment of the present invention will be described in detail with reference to the drawings. In the present embodiment, a numerical control system and a numerical control device are described as an example of a control system and a control device. However, the present invention is not particularly limited to the numerical control system and the numerical control device. The numerical control system and the numerical control device create numerical data for driving a machine tool, a robot, or an industrial machine, for example. Moreover, the control device may be a programmable logic controller (PLC).

In the embodiment to be described later, an example in which one communication terminal is connected to one numerical control device is illustrated. However, a plurality of communication terminals may be connected to one numerical control device. For example, a production manager may want to display some contents images of a machining program editing screen of a machining operation screen of a numerical control device and some contents images of a tool information management screen on a communication terminal connected to a numerical control device as a production management screen in order to perform production management. A maintenance manager may want to display some contents images of a tool state checking screen of a state monitoring screen for monitoring the state of a numerical control device and some contents images of a tool information management screen on another communication terminal connected to the same numerical control device as a maintenance management screen in order to perform maintenance management. As described above, when a plurality of communication terminals of one numerical control device want to combine contents necessary for respective purposes to form a screen, according to the numerical control system, the numerical control device, and the communication terminal of the present embodiment, it is possible to obtain a screen including the contents images conforming to the purpose of an operator.

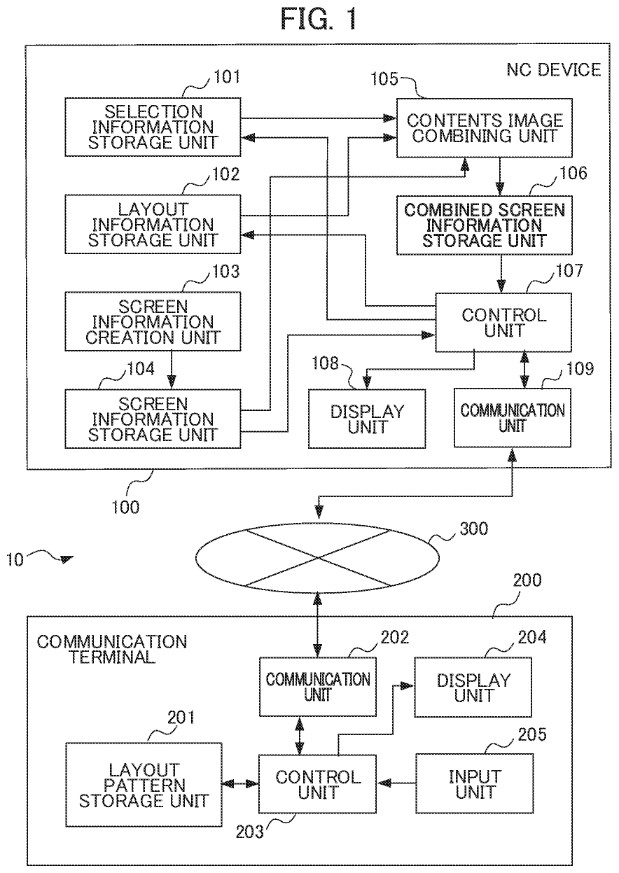

FIG. 1 is a block diagram illustrating a configuration of a numerical control system according to a first embodiment of the present invention. A numerical control system 10 illustrated in FIG. 1 includes a numerical control device (a NC device) 100, a communication terminal 200, and a network 300.

First, the numerical control device 100 will be described. The numerical control device 100 includes a selection information storage unit 101, a layout information storage unit 102, a screen information creation unit 103 serving as a first screen information creation unit, a screen information storage unit 104 serving as a first screen information storage unit, a contents image combining unit 105 serving as a second screen information creation unit, a combined screen information storage unit 106 serving as a second screen information storage unit, a control unit 107, a display unit 108, and a communication unit 109. The numerical control device 100 further includes a component (not illustrated) that creates numerical data for driving a machine tool, a robot, or an industrial machine in addition to the components illustrated in FIG. 1. Although an external storage device such as a hard disk can be used as the selection information storage unit 101, the layout information storage unit 102, the screen information storage unit 104, and the combined screen information storage unit 106, a semiconductor memory or a main memory inside a CPU may be used, and a nonvolatile storage device such as a flash memory may be used.

The selection information storage unit 101 stores selection information of contents images selected by an operator of the communication terminal 200 and sequentially transmitted from the communication terminal 200. The contents images are contents images of a screen to be displayed on a display unit 204 of the communication terminal 200. One or more contents images form one screen. A contents image selection operation and the selection information will be described later.

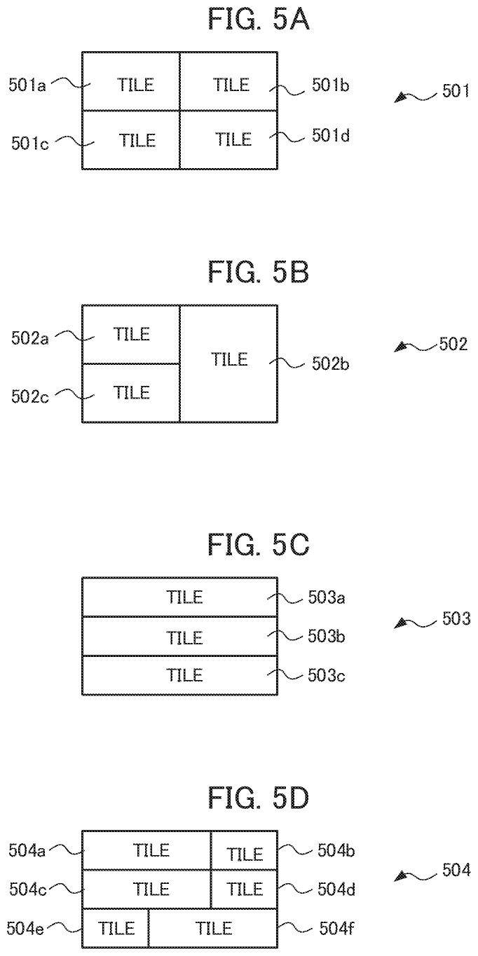

The layout information storage unit 102 selects a layout pattern selected by the operator of the communication terminal 200 and transmitted from the communication terminal 200. The layout pattern includes one or more regions to which contents images are allocated and this region is referred to as a tile. The stored layout pattern is a layout pattern selected from the layout patterns 501 to 504 illustrated in FIGS. 5A to 5D to be described later, for example. The layout patterns 501 to 504 each include a plurality of tiles, and for example, the layout pattern 502 illustrated in FIG. 5B includes three tiles 502a, 502b, and 502c. A layout pattern may include only one tile.

The screen information creation unit 103 creates screen information (serving as first screen information) of a screen to be displayed on the display unit 108. The screen information is image information of a screen. The screen information storage unit 104 stores the screen information created by the screen information creation unit 103. A screen related to the stored screen information is a machining operation screen for performing a machining operation, a state monitoring screen for monitoring the state, a calendar screen for checking a plan, a manual display screen showing operations of a machine, or a tool information management screen, for example. Bach of these screens includes a plurality of screens. For example, the machining operation screen includes a machining program editing screen, a procedure screen showing the procedures before machining, and a machining display screen showing the state during machining. Moreover, the state monitoring screen includes an alarm monitoring screen, a tool state checking screen, and a screen showing information including the position, the velocity, and the like of a feed axis or a spindle of a servo motor. The screen information creation unit 103 rewrites information of the contents images included in the screen information. A screen ID is assigned to each screen information, and a contents ID is assigned to each contents image included in each screen information.

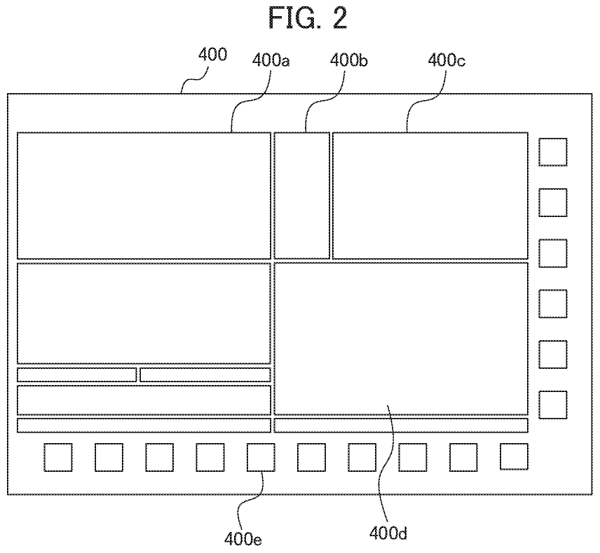

FIG. 2 is a diagram illustrating a configuration example of a machining display screen displayed on a display unit according to screen information. As illustrated in FIG. 2, a machining display screen 400 includes contents 400a showing the X, Y, and Z coordinates, contents 400b showing a load to be machined, contents 400c showing a first machining program, contents 400d showing a second machining program, and a plurality of buttons 400e such as a screen switching button and a contents information switching button. The respective images indicating the contents 400a to 400d are contents images. FIG. 2 illustrates an example of a screen layout and contents, and the screen layout and the contents are not limited thereto. The screen information creation unit 103 rewrites the numerical values of the X, Y, and Z coordinates of the contents image showing the contents 400a.

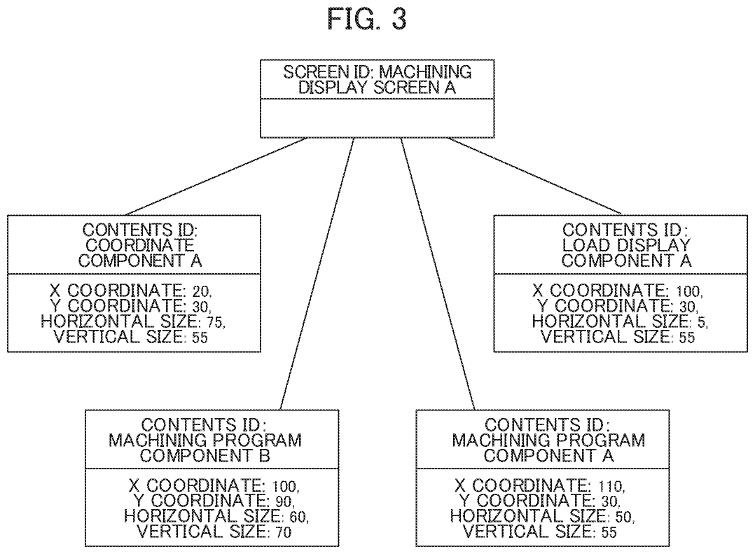

The screen information and the contents image included in each screen information are stored in the screen information storage unit 104 together with a screen ID and a contents ID, respectively. FIG. 3 is a diagram illustrating an example of a screen ID, a contents ID, and the arrangement information of contents images stored in the screen information storage unit. For example, as illustrated in FIG. 3, in the case of the screen information of the machining display screen illustrated in FIG. 2, “machining display screen A” is assigned as a screen ID of the screen information of the machining display screen, “coordinate component A” is assigned as a contents ID of the contents image of the contents 400a, “load display component A” is assigned as a contents ID of the contents image of the contents 400b, “machining program component A” is assigned as a contents ID of the contents image of the contents 400c, and “machining program component B” is assigned as a contents ID of the contents image of the contents 400d. The contents IDs are stored in the screen information storage unit 104 in association with the X and Y coordinates of the top-left corner of each contents image and the horizontal and vertical sizes of each contents image. When the screen information stored in the screen information storage unit 104 is to be read, the selection information stored in the selection information storage unit 101 is used.

The selection information stored in the selection information storage unit 101 is created by the communication terminal 200. When the communication terminal 200 designates the contents image using a range selection mode to be described later, the selection information includes information indicating the range selection mode, information (a screen ID or the like) indicating an image page, and information indicating the coordinate values such as the X and Y coordinates of the top-left corner of the contents image and the X and Y coordinates of the bottom-right corner. When the communication terminal 200 designates the contents image using an object selection mode to be described later, the selection information includes information indicating the object selection mode, information. (a screen ID or the like) indicating an image page, and the X and Y coordinates of the contents image of a tapped portion of contents displayed on a display unit.

When a contents image of the screen information stored in the screen information storage unit 104 is specified using the selection information of the range selection mode to be described later, the contents image combining unit 105 can specify a contents image by selecting the screen ID of the screen information stored in the screen information storage unit 104, the X and Y coordinates of the top-left corner of the contents image, and the horizontal and vertical sizes of each contents image using the screen ID included in the selection information, the X and Y coordinates of the top-left corner of the contents image, and the X and Y coordinates of the bottom-right corner of the contents image. The horizontal and vertical sizes of the contents image can be obtained by calculating a difference between the X coordinates of the top-left corner and the bottom-right corner of the contents image and a difference between the Y coordinates of the top-left corner and the bottom-right corner of the contents image. When the contents image of the screen information stored in the screen information storage unit 104 is specified using the selection information of the object selection mode to be described later, the contents image combining unit 105 can specify the contents image by determining whether the screen. ID included in the selection information and the X and Y coordinates of the contents image of the tapped portion belong to a range specified by the X and Y coordinates of the top-left corner of the contents image and the horizontal and vertical sizes of each contents image stored in the screen information storage unit 104.

The contents image combining unit 105 reads the layout pattern stored in the layout information storage unit 102 and reads the selection information stored in the selection information storage unit 101. Moreover, the contents image combining unit 105 reads the contents images specified on the basis of the selection information from the screen information storage unit 104 and arranges the contents images in tiles of the layout pattern to create combined screen information.

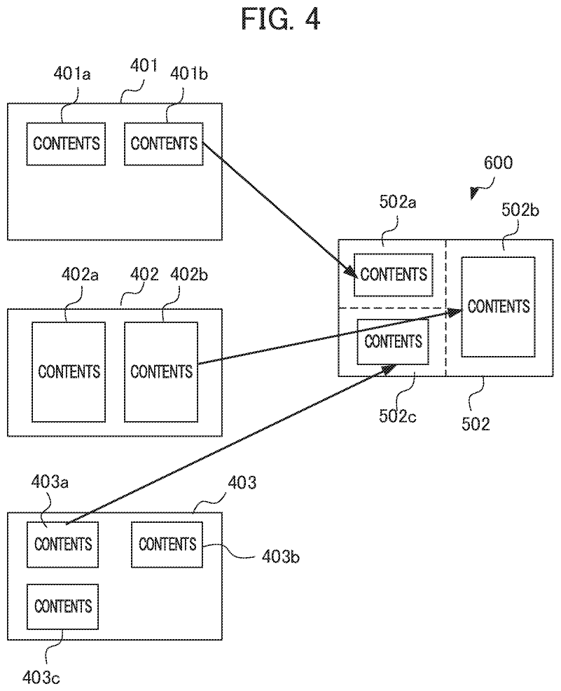

An operation of the contents image combining unit 105 will be described as an example. FIG, 4 is a diagram illustrating how the contents image combining unit, arranges three contents images of three pieces of screen information in tiles of the layout pattern to create the combined screen information FIG. 4 illustrates, screen information, contents images, screens displayed on a display unit according to the combined screen information, contents, and a combined screen. In FIG. 4, a screen 401 includes contents 401a and 401b, a screen 402 includes contents 402a and 402b, and a screen 403 includes contents 403a, 403b, and 403c. The screen information of the screens 401 to 403 are stored together with the screen IDs thereof and the contents images of the contents 401a, 401b, 402a, 402b, and 403a to 403c are stored together with the X and Y coordinates of the top-left corner of each of the contents images in the screen information storage unit 104. The layout information storage unit 102 stores a layout pattern 502 illustrated in FIG. 5B. Moreover, the selection information storage unit 101 stores a combination of the screen ID of the screen information of the screen 401 and the X and Y coordinates of the contents image of the contents 401b, a combination of the screen ID of the screen information of the screen 402 and the X and Y coordinates of the contents image of the contents 402b, and a combination of the screen. ID of the screen information of the screen 403 and the X and Y coordinates of the contents image of the contents 403a.

The contents image combining unit 105 reads the layout pattern 502 illustrated in FIG. 5B from the layout information storage unit 102 and reads the selection information (for example, the screen ID of the screen information of the screen 401 and the X and. Y coordinates of the contents image of the contents 401b, the screen ID of the screen information of the screen 402 and the X and Y coordinates of the contents image of the contents 402b, and the screen ID of the screen information of the screen 403 and the X and Y coordinates of the contents image of the contents 403a in the object selection mode) from the selection information storage unit 101. The selection information stored in the selection information storage unit 101 is stored in correspondence to the arrangement of tiles of the layout pattern. A correspondence between the selection information and the arrangement of tiles of the layout pattern is determined by an operator of the communication terminal 200 as will be described later. As illustrated in FIG. 4, the contents image combining unit 105 arranges the contents images of the contents 401b, 402b, and 403a read from the screen information storage unit 104 in the tiles 502a, 502b, and 502c of the layout pattern 502 on the basis of the selection information. The image information of the layout pattern 502 in which the contents 401b, 402b, and 403a are arranged is combined screen information 600.

The combined screen information storage unit 106 stores the combined screen information combined by the contents image combining unit 105. The display unit 108 reads the respective pieces of screen information stored in the screen information storage unit 104 and displays the screen information. The communication unit 109 communicates with the communication terminal 200.

The control unit 107 performs control of storing information in the selection information storage unit 101 and the layout information storage unit 102 and reading the stored information from the screen information storage unit 104 and the combined screen information storage unit 106. Moreover, the control unit 107 controls the operations of the screen information creation unit 103, the contents image combining unit 105, the display unit 108, and the communication unit 109.

Next, the communication terminal 200 will be described. The communication terminal 200 includes a layout pattern storage unit 201, a communication unit 202, a control unit 203, a display unit 204, and an input unit 205. The communication terminal 200 can communicate with the numerical control device 100, and for example, the communication terminal 200 is a portable phone such as a smartphone or a tablet or notebook personal computer, for example.

The layout pattern storage unit 201 stores the layout patterns 501 to 504 illustrated in FIGS. 5A to 5D, for example. The layout pattern 501 illustrated in FIG. 5A has four tiles 501a to 502d of the same size. The layout pattern 502 illustrated in FIG. 5B has two tiles 502a and 502c of the same size and a tile 502b having a larger size than the tiles 502a and 502c. The layout pattern 503 illustrated in FIG. 5C has three tiles 503a to 503c of the same size arranged in a vertical direction. The layout pattern 504 illustrated in FIG. 5D has three tiles 504a, 504c, and 504f of the same size and three tiles 504b, 504d, and 504e having a smaller size than the three tiles 504a, 504c, and 504f. The layout patterns 501 to 504 illustrate an example of the layout patterns stored in the layout pattern storage unit 201 and there is no limitation to these layout patterns. The layout pattern may include only one tile. For example, if the screen information of the machining display screen illustrated in FIG. 2 is stored in the screen information storage unit 104, when only the contents image of the contents 400a in the machining display screen illustrated in FIG. 2 is arranged in a tile and the other contents images are not arranged, the layout pattern having only one tile may be used. The layout pattern may be created by an operator of the communication terminal 200 and be stored in the layout pattern storage unit 201. Alternatively, the layout pattern may be created by an operator of the numerical control device 100 and be transmitted to the communication terminal 200 and be stored in the layout pattern storage unit 201. Although an external storage device such as a hard disk can be used as the layout pattern storage unit 201, a semiconductor memory or a main memory inside a CPU may be used, and a nonvolatile storage device such as a flash memory may be used.

The communication unit 202 communicates with the numerical control device 100. The control unit 203 performs control of reading the layout pattern stored in the layout pattern storage unit 201 and controls the operations of the communication unit 202, the display unit 204, and the input unit 205. Hereinafter, the operation of the control unit 203 will be described in detail. The control unit 203 reads the layout pattern of a screen to be displayed on the display unit 204 from the layout pattern storage unit 201 and displays the screen on the display unit 204. The control unit 203 may sequentially display the images of the layout patterns 501 to 504 on the display unit 204 and may generate the thumbnails (reduced images) of the images of the layout patterns 501 to 504 and display the same on the display unit 204 as a list. Moreover, the control unit 203 transmits the layout information of any one of the layout patterns 501 to 504 selected by an operator watching the display unit 204 with the aid of the input unit 205 to the numerical control device 100 via the communication unit 202. The control unit 203 stores the selected layout pattern therein.

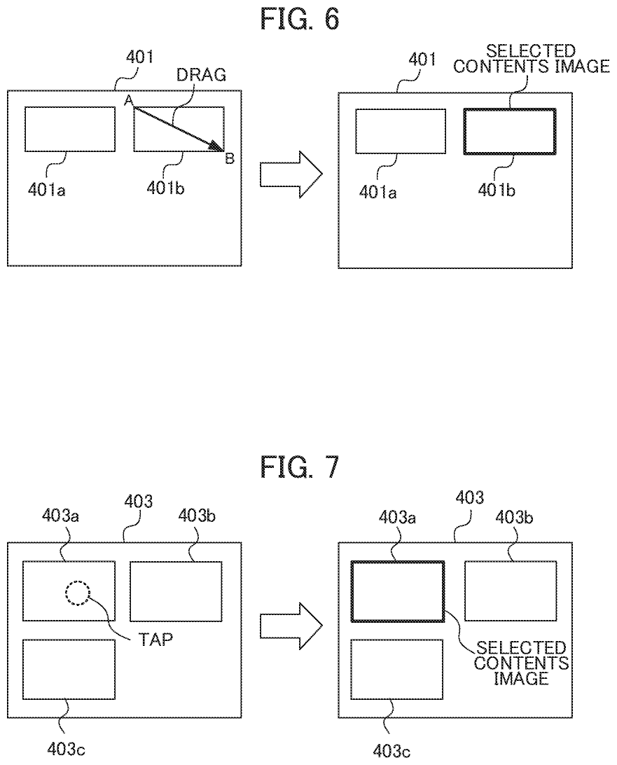

Furthermore, the control unit 203 sends a transmission request for all pieces of screen information or necessary pieces of screen information stored in the screen information storage unit 104. The control unit 203 sequentially displays one or more pieces of screen information received via the communication unit 202 to the display unit 204. An operator selects a contents image on the screen displayed on the display unit 204 according to the screen information using a contents image selection method illustrated in FIG. 6 or 7. The operator sequentially selects a number of contents images corresponding to the number of tiles of the layout pattern transmitted to the numerical control device 100. In this case, the order of selecting contents images is the arrangement order of tiles. For example, in the case of the layout pattern 502 illustrated in FIG. 5B, the operator selects contents images in the order of the tiles 502a, 502b, and 502c. The control unit 203 sequentially transmits the selection information related to the selected contents images to the numerical control device 100 in the selection order of the contents images. As described with reference to FIG. 4, the selection information is the information on the contents 401b of the screen 401, the contents 402b of the screen 402, and the contents 403a of the screen 403.

A range selection method and an object selection method are used as a method of selecting contents images from the screen information. Contents images are selected by an operator of the communication terminal 200 while watching the screen of the display unit 204. In the following description, the range selection method and the object selection method will be described by way of examples of a case in which the contents 401b of the screen 401 illustrated in FIG. 6 is selected by a mouse-drag and a case in which the contents 403a of the screen 403 illustrated in FIG. 7 is selected by a tap on a touch panel. The screen 401 includes contents 401a and 401b, and the screen 403 includes three contents 403a to 403c.

For example, range selection is performed in such a way that the control unit 203 receives the screen information of the screen 401 from the numerical control device 100 and the operator drags from a top-left corner A of the contents 401b of the screen 401 displayed on the display unit 204 to a bottom-right corner B using a mouse serving as the input unit 205 on the basis of the screen information. With this operation, a contents image corresponding to the contents 401b in the range designated by the drag from the top-left corner A to the bottom-right corner B is selected. In FIG. 6, the selected contents image is indicated by a hold-line rectangular block. The selection information of the contents image of the contents 401b includes information indicating a range selection mode, information (a screen ID or the like) indicating an image page, and information indicating the coordinate value such as the X and Y coordinates of the top-left corner A and the X and Y coordinates of the bottom-right corner B. Object selection is performed in such a way that the control unit 203 receives the screen information of the screen 403 from the numerical control device 100, and the operator taps on the contents 403a of the screen 403 displayed on the display unit 204 on the basis of the screen information. With this operation, a contents image corresponding to the tapped contents 403a is selected. In FIG. 7, the selected contents image is indicated by a bold-line rectangular block. The selection information of the contents image of the contents 403a includes information indicating an object selection mode, information (a screen ID or the like) indicating an image page, and information indicating the coordinate value of the tapped portion. The tapping on contents may be changed to a mouse-click operation on contents.

The display unit 204 displays the screen information transmitted from the numerical control device 100. The input unit 205 is a keyboard, a mouse, or the like that switches the screen to be displayed on the display unit 204 and performs a drag illustrated in FIG. 6. When a touch panel is used in the display unit 204, since the display unit 204 has an input function, the input unit 205 may not be provided. A tap illustrated in FIG. 7 illustrates an operation when a touch panel is used.

The network 300 connects the numerical control device 100 and the communication terminal 200 so as to communicate with each other. The network 300 is a local area network (LAN) constructed in a plant, the Internet, a public telephone network, or a combination thereof, for example. A specific communication scheme of the network 300, whether the network uses a cable connection or a wireless connection, and the like are not particularly limited.

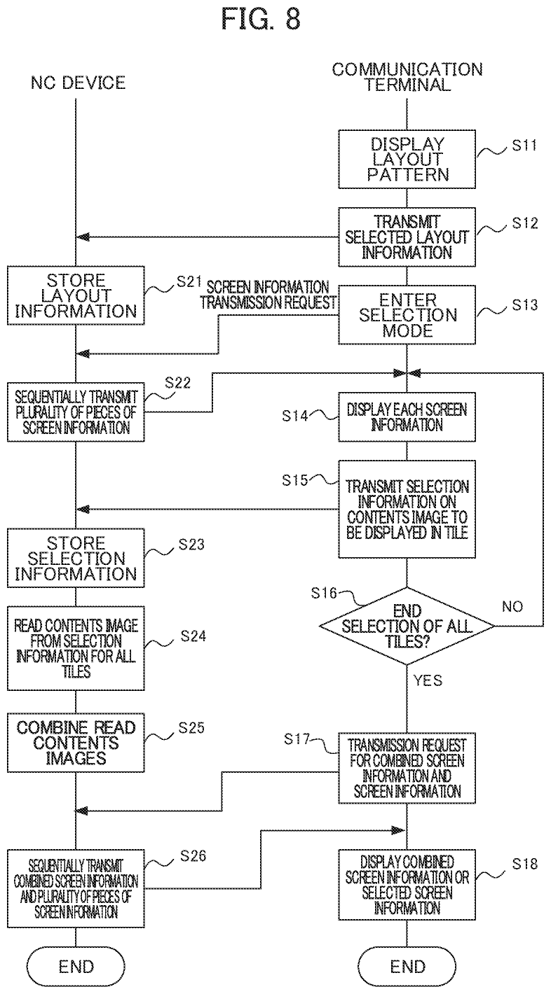

Hereinafter, the operations of the numerical control device 100 and the communication terminal 200 that form the numerical control system 10 will be described with reference to FIG. 8. FIG. 8 is a flowchart illustrating the operations of the numerical control device 100 and the communication terminal 200 that form the numerical control system. In FIG. 8, steps S11 to S18 illustrate the operation of the communication terminal 200 and steps S21 to S26 illustrate the operation of the numerical control device 100.

An operator of the communication terminal 200 selects a screen editing mode using the input unit 205. In step S11, the control unit 203 reads a layout pattern of a screen to be displayed on the display unit 204 from the layout pattern storage unit 201 and displays the screen on the display unit 204. The control unit 203 may sequentially display the images of the layout patterns 501 to 504 on the display unit 204 and may generate the thumbnails (reduced images) of the images of the layout patterns 501 to 504 and display the same on the display unit 204 as a list.

Subsequently, in step S12, the control unit 203 transmits the layout information of any one of the layout patterns 501 to 504 selected by an operator watching the display unit 204 with the aid of the input unit 205 to the numerical control device 100 via the communication unit 202. Moreover, the control unit 203 stores the selected layout pattern therein. In this example, it is assumed that the control unit 203 transmits the layout information of the layout pattern 502 illustrated in FIG. 5B to the numerical control device 100 and stores the layout information therein.

In step S21, upon receiving the layout information transmitted from the communication terminal 200 via the communication unit 109, the control unit 107 of the numerical control device 100 stores the layout information in the layout information storage unit 102.

In step S13, the control unit 203 of the communication terminal 200 enters a selection mode, selects all pieces of screen information or necessary pieces of screen information stored in the screen information storage unit 104 of the numerical control device 100 via the communication unit 202, and transmits a transmission request.

In step S22, upon receiving the transmission request for a plurality of pieces of screen information via the communication unit 109, the numerical control device 100 sequentially transmits the screen information selected by the operator to the communication terminal 200 via the communication unit 109.

In step S14, the control unit 203 of the communication terminal 200 displays the screen information received via the communication unit 202 on the display unit 204. The operator switches a screen to be displayed on the display unit 204 to select a screen including a contents image that is to be displayed. For example, when a contents image corresponds to the contents 401b of the screen 401 illustrated in FIG. 4, the screen 401 is displayed on the display unit 204. The operator selects the contents 401b, for example, which is an image to be selected, using the contents image selection method illustrated in FIG. 6 or 7 on the screen displayed on the display unit 204. The contents 401b is a contents image to be allocated to the tile 502a of the layout pattern 502 illustrated in FIG. 5B.

In step S15, the control unit 203 transmits selection information related to the contents 401b to be allocated to the tile 502a of the layout pattern 502 to the numerical control device 100.

In step S16, the control unit 203 determines whether all of the plurality of contents images to be displayed in all tiles have been selected. When selection of the contents for all tiles has not ended (step S16: NO), the flow returns to step S14, and the processes of steps S14 to S16 are repeated. For example, as illustrated in FIG. 4, the processes of steps S14 to S16 are repeated until the selection information related to the contents 402b to be allocated to the tile 502b of the layout pattern 502 and the selection information related to the contents 403a to be allocated to the tile 502c are transmitted to the numerical control device 100. When selection of the contents for all tiles has ended (step S16: YES), the flow proceeds to step S17.

In step S23, upon receiving the selection information transmitted from the communication terminal 200 via the communication unit 109, the control unit 107 of the numerical control device 100 sequentially stores the selection information in the selection information storage unit 101.

In step S24, upon receiving the selection information for all tiles of the layout pattern of the layout information stored in the layout information storage unit 102, the contents image combining unit 105 reads the layout pattern from the layout information storage unit 102 and reads the contents images for all tiles from the screen information storage unit 104 on the basis of the selection information

In step S25, the contents image combining unit 105 arranges the read contents images in the tiles of the layout pattern and combines the contents images to create combined screen information.

In step S17, the communication terminal 200 transmits a transmission request for the combined screen information and a transmission request for the screen information.

In step S26, when a transmission request for the combined screen information and the screen information is transmitted from the communication terminal 200, the control unit 107 sequentially transmits the created combined screen information and all or some pieces of screen information stored in the screen information storage unit 104 to the communication terminal 200. In step S18, upon receiving the combined screen information and all or some pieces of screen information from the numerical control device 100, the control unit 203 displays the combined screen information or the selected screen information on the display unit 204. The operator can switch a screen to be displayed on the display unit 204 to either the screen based on the combined screen information or the screen based on the screen information as necessary. In step S17, the communication terminal 200 may transmit a transmission request for the combined screen information or the screen information. In this case, in step S26, the control unit 107 transmits the created combined screen information or all or some pieces of screen information stored in the screen information storage unit 104 to the communication terminal 200. In step S18, the control unit 203 displays the received combined screen information or the received screen information on the display unit 204.

While the embodiments of the present invention have been described, the components included in the control device and the communication terminal may be realized by hardware, software or a combination thereof. The servo control method performed by cooperation of the components included in the servo control device described above also may be realized by hardware, software, or a combination thereof. Here, being realized by software means being realized when a computer reads and executes a program.

When the numerical control device 100 and the communication terminal 200 are realized by cooperation of hardware and software, the numerical control device 100 and the communication terminal 200 each include an arithmetic processing unit such as a central processing unit (CPU). Moreover, the numerical control device 100 and the communication terminal 200 each further include an auxiliary storage device such as a hard disk drive (HDD) for storing various control programs such as application software or an operating system (OS) and a main storage device such as a random access memory (RAM) for storing data temporarily required when the arithmetic processing device executes a program.

In each of the numerical control device 100 and the communication terminal 200, the arithmetic processing device reads an application and an OS from the auxiliary storage device, and develops the read application software and OS in the main storage device to perform arithmetic processing on the basis of the read application software and OS. The arithmetic processing device also controls various types of hardware provided in each device based on the arithmetic result. In this way, the functional blocks of the present embodiment are realized. That is, the present embodiment can be realized by cooperation of hardware and software.

The programs can be stored on any of various types of non-transitory computer readable media and be provided to a computer. The non-transitory computer readable media include various types of tangible storage media. Examples of the non-transitory computer readable media include a magnetic recording medium (for example a flexible disk, a magnetic tape, and a hard disk drive), a magneto-optical recording medium (for example a magneto-optical disk), a CD-ROM (Read Only Memory), a CD-R, a CD-R/W, a semiconductor memory (for example a mask ROM, a PROM (Programmable ROM), an EPROM: (Erasable PROM), a flash ROM, and a RAM (Random Access Memory)).

The above-described embodiment is a preferred embodiment of the present invention. However, the scope of the present invention is not limited to the embodiment only but the present invention can be embodied in various modifications without departing from the spirit of the present invention.

For example, in the numerical control system 10 illustrated in FIG. 1, the layout pattern storage unit is disposed in the communication terminal. However, the layout pattern storage unit may be disposed in the numerical control device, a plurality of layout patterns may be transmitted to the communication terminal, the operator of the communication terminal may select a layout pattern from a plurality of transmitted layout patterns and transmit the selected layout pattern to the numerical control device.

The screen information transmitted from the numerical control device 100 to the communication terminal 200 may be one piece of screen information having a plurality of contents images, a plurality of pieces of screen information each having one contents image, or a plurality of pieces of screen information each having a plurality of contents images. The operator of the communication terminal 200 may select one or more contents images from a plurality of contents images included in one piece of screen information. Alternatively, the operator may select one or more contents images from a plurality of pieces of screen information each having one contents image. Alternatively, the operator may select one or more contents images from a plurality of pieces of screen information each having a plurality of contents images. The communication terminal 200 can obtain combined screen information such that one or more contents images are arranged in a layout pattern, from the numerical control device 100.

Some or all components of the numerical control device 100 illustrated in FIG. 1 may form a web server. The communication unit 109 and at least some of the screen information creation unit 103, the contents image combining unit 105, the screen information storage unit 104, and the combined screen information storage unit 106 are included in the web server. For example, when the communication unit 109 and the screen information storage unit 104 are included in the web server, the communication terminal 200 can access (that is, transmit a transmission request to) the web server using a browser and browse all or necessary pieces of screen information stored in the screen information storage unit 104 on a webpage. Moreover, when the communication unit 109 and the combined screen information storage unit 106 are included in the web server, the communication terminal 200 can access (that is, transmit a transmission request to) the web server using a browser and browse the combined screen information stored in the combined screen information storage unit 106 on a webpage. When the contents image included in the screen information of the webpage is selected using the contents image selection method illustrated in FIG. 6 or 7, the communication terminal 200 uses a terminal application of the communication terminal 200 or an applet, for example. The communication terminal 200 includes an application program interface which enables a contents image included in the screen information of the webpage to be used by the terminal application. The terminal application or the applet transmits selection information of selecting the contents image to the numerical control device 100.

### EXPLANATION OF REFERENCE NUMERALS

10: Numerical control system
100: Numerical control device (NC device)
101: Selection information storage unit
102: Layout information storage unit
103: Screen information creation unit (First screen information creation unit)
104: Screen information storage unit (First screen information storage unit)
105: Contents image combining unit (Second screen information creation unit)
106: Combined screen information storage unit (Second screen information storage unit)
107: Control unit
108: Display unit
109: Communication unit
200: Communication terminal
201: Layout pattern storage unit
202: Communication unit
203: Control unit
204: Selection information storage unit
204: Display unit
205: Input unit.
300: Network

1. A control device comprising:
a communication unit that communicates with a communication terminal;
a first screen information creation unit that creates at least one piece of first screen information; and
a second screen information creation unit that creates second screen information including the contents image on the basis of at least one contents image selected from the first screen information by the communication terminal and layout information of a screen selected by the communication terminal, wherein
the communication unit transmits the first screen information and the second screen information to the communication terminal and receives the layout information of the screen and the contents image or the selection information of the contents image from the communication terminal.

2. The control device according to claim 1, further comprising:
a first screen information storage unit that stores the first screen information, wherein
the communication unit receives selection information of the contents image, and
the second screen information creation unit arranges the contents image selected from the first screen information stored in the screen information storage unit in a layout pattern of the layout information on the basis of the selection information.

3. The control device according to claim 2, further comprising:
a second screen information storage unit hat stores the second screen information; and
a control unit that transmits at least one of the second screen information stored in the second screen information storage unit and the screen information stored in the first screen information storage unit via the communication unit on the basis of a transmission request from the communication terminal.

4. The control device according to claim 3, wherein
the communication unit and at least some of the first screen information creation unit, the second screen information creation unit, the first screen information storage unit, and the second screen information storage unit form a web server.

5. The control device according to claim 1, wherein
the control device is a numerical control device that creates numerical information for driving a machine tool, a robot, or an industrial machine.

6. A communication terminal comprising:
a communication unit that communicates with a control device;
a display unit; and
a layout pattern storage unit that stores at least one layout pattern for arranging at least one contents image on a screen to be displayed on the display unit, wherein
the communication unit transmits one layout pattern stored in the layout pattern storage unit to the control device, receives first screen information including at least one contents image from the control device, transmits selection information for selecting a contents image from the first screen information to the control device, and receives second screen information in which the contents image selected on the basis of the selection information is arranged in the one layout pattern from the control device.

7. The communication terminal according to claim 6, wherein the first screen information and the second screen information are received by a browser.

8. A control system comprising:
the control device according to claim 1; and
a communication terminal comprising:
a communication unit that communicates with a control device;
a display unit and
a layout pattern storage unit that stores at least one layout pattern for arranging at least one contents image on a screen to be displayed on the display unit, wherein
the communication unit transmits one layout pattern stored in the layout pattern storage unit to the control device, receives first screen information including at least one contents image from the control device, transmits selection information for selecting a contents image from the first screen information to the control device, and receives second screen information in which the contents image selected on the basis of the selection information is arranged in the one layout pattern from the control device.
